(19) United States
(12) Patent Application Publication
(10) Pub. No.: US 2025/0040574 A1
(43) Pub. Date: Feb. 6, 2025

(54) PLANT BASED READY TO MIX COMPOSITION

(71) Applicant: DSM IP Assets B.V., Heerlen (NL)

(72) Inventors: Maartje Maria FRANSE, Echt (NL); Johanna Corline Margriet VINK, Echt (NL); Mirna BOSNJAK, Echt (NL)

(21) Appl. No.: 18/691,213

(22) PCT Filed: Aug. 29, 2022
(86) PCT No.: PCT/EP2022/073984

§ 371 Date: Mar. 12, 2024

(30) Foreign Application Priority Data
Sep. 16, 2021 (EP) 21197093.4

(51) Int. Cl. A23L 2/66; A23L 2/56; A23L 2/60; A23L 29/238; A23L 33/15; A23L 33/21

(52) U.S. Cl. CPC A23L 2/66; A23L 2/56; A23L 2/60; A23L 29/238; A23L 33/15; A23L 33/21

(57) ABSTRACT

The present invention relates to a ready to mix composition comprising 30 to 60 wt. % pea and rapeseed protein, 5 to 25 wt. % dietary fiber, 0 to 15 wt. % creaming agent, 1 to 15 wt. % flavor and 0.1 to 5 wt. % hydrocolloid, wherein the ratio of pea and rapeseed protein is within the range of 80:20 to 20:80.

### FIELD OF THE INVENTION

The present invention is directed to a ready to mix composition comprising pea protein, rapeseed protein, dietary fiber, creaming agent and a hydrocolloid, and to the use of such composition in food products such as a beverage.

### BACKGROUND OF THE INVENTION

Food products comprising plant proteins as alternative to animal-derived proteins nowadays receive attention because of consumer concerns about the environmental impact of animal-based products and the beneficial nutritional characteristics of plant-based foods. In particular, beverages based on plant proteins as alternative to dairy products such as milk, yoghurt or ice cream have gained popularity. Plant proteins may be derived from a variety of legumes and pulses such as soybean, pea, chickpea, fava bean, lentil, mung bean, peanut, lupin; oil seeds/cabbages such as rapeseed or canola, sunflower, camelina, sesame; cereals and pseudo cereals, such as wheat, barley, oat, rice, sorghum, quinoa, buckwheat; nuts, such as almond, hazelnut, walnut, cashew; coconut; nightshades such as potato. In ready to mix (RTM) protein beverages popular used protein sources are pea, brown rice, chia, pumpkin, sunflower, and alfalfa.

RTM protein beverages are an increasingly popular type of product. RTM's are powder formulations that are solubilized by the consumer in water, usually before consumption. As being a good source of protein, RTM protein beverages target two main different groups of consumers.

The first category of RTM protein beverages targets weigh management. This category comprises usually 30-40% protein, should be low in calories and should contain dietary fibers.

A second category of RTM protein beverages targets sport drinks. Consumers of sport drink are keen on high protein, usually 40-60% protein, and appreciate a more elevated sensory perception.

For both categories of RTM protein beverages, it is important that they have a pleasant aftertaste, with a creamy and smooth mouthfeel, without coating the mouth or throat.

Unfortunately, addition of plant proteins in beverages often provides a protein like flavor and aroma to the beverage. Further, plant protein beverages suffer from a texture that is astringent and chalky. Pea protein is an increasingly popular used protein source, but also pea suffers from these disadvantages, also when combined with brown rice, chia, pumpkin, sunflower or alfalfa.

There is therefore a need for a ready to mix composition that does not lead to any or all of the problems mentioned above.

### DETAILED DESCRIPTION OF THE INVENTION

The objective of the present invention is to solve the problems mentioned above. This objective is met by providing a ready to mix composition according to the appended claims.

More specially, the invention relates to a ready to mix composition comprising 30 to 60 wt. % pea and rapeseed protein, 5 to 25 wt. % dietary fiber, 0 to 15 wt. % creaming agent, 1 to 15 wt. % flavor and 0.1 to 5 wt. % hydrocolloid, wherein the (weight) ratio of pea and rapeseed protein is within the range of 80:20 to 20:80, preferably wherein the total amount is 100 wt. % or less than 100 wt. %.

The present inventions surprisingly found that the ready to mix composition of the invention provides a protein beverage having a reduced protein flavor and aroma, and a texture that is not perceived as astringent and chalky. Hence, by combining pea protein with rapeseed protein, the disadvantageous sensory attributes of pea are solved.

In the context of the present invention, the term “ready to mix composition” refers to a (powder) composition that is ready for human consumption after solubilizing/dispensing (the powder) to water.

In the context of the present invention, the term “chalkiness” refers to the degree to which the sample feels as though it contains very small particles, reminiscent of chalk dust, after being chewed. Preferably, the present ready to mix composition is less chalky than a comparable composition without rapeseed protein.

In the context of the present invention, the term “astringent” refers to the degree of the chemical feeling factor on the tongue or other skin surfaces of the oral cavity described as puckering/dry and associated with tannins or alum. Preferably, the present ready to mix composition is less astringent than a comparable composition without rapeseed protein.

In the context of the present invention the term “comprising 30 to 60 wt. % pea and rapeseed protein” refers to the sum of the amount of pea and rapeseed protein. Preferably the present ready to mix composition does not comprise other plant protein sources.

Preferably, the (weight) ratio of pea and rapeseed protein is within the range of 75:15 to 15:75, 70:30 to 30:70; 65:35 to 35:65, 60:40 to 40:60, or 55:45 to 45:50, or any combination of the lower and upper limits.

In a preferred embodiment, the present (weight) ratio of pea and rapeseed protein is within the range of 60:40 to 40:60, such as 59:41 to 41:59, 58:42 to 42:58; 57:43 to 43:57; 56:44 to 44:56; 55:45 to 45:55, 54:46 to 46:54, such as around 50:50.

In a preferred embodiment, the present (weight) ratio of pea and rapeseed protein is within the range of 50:50 to 95:5, preferably 50:50 to 80:20, preferably 50:50 to 75:25, preferably 50:50 to 60:40.

The present ready to mix composition may be in the form of a gel, chew, powder, capsule, tablet, sachet or bar. Preferably the present ready to mix composition is in the form of a powder. More preferably a powder having an amount of moisture of less than 10 wt. %, such as less than 8 wt. %, less than 5 wt. % or even less than 3 wt. %.

In a preferred embodiment, the present ready to mix composition further comprises 0.01 to 5 wt. % of a sweetener. More preferably the amount of sweetener is within the range of 0.1 to 3 wt. %, such as 1 to 2 wt. %. The sweetener can be a low-calorie sweetener. Preferably, the sweetener is chosen from the group of aspartame, sucralose, sugar alcohols and steviol glycosides.

Preferably, the present ready to mix composition does not comprise soy, soy protein, dairy protein. More preferably the present ready to mix composition is suitable to be sold as vegan.

In a preferred embodiment the present ready to mix composition comprises 35 to 45 wt. % pea and rapeseed protein, 10 to 25 wt. % dietary fiber, 10 to 15 wt. % creaming agent, 1 to 15 wt. % flavor and 1 to 4 wt. % hydrocolloid. Preferably wherein the total amount is 100 wt. % or less than 100 wt. %. Such an RTM is particularly useful for weight management purposes, as it provides sufficient amounts of protein and fiber, while maintaining advantageous sensory properties like absence of protein aroma and flavour, astringency and chalkiness.

In a preferred embodiment, the present ready to mix composition comprises 45 to 60 wt. % pea and rapeseed protein, 1 to 10 wt. % dietary fiber, 5 to 15 wt. % creaming agent, 1 to 15 wt. % flavor and 0.1 to 3 wt. % hydrocolloid. Preferably wherein the total amount is 100 wt. % or less than 100 wt. %. Such an RTM is particularly useful for sport purposes, as it provides high amounts of protein and fiber, while maintaining advantageous sensory properties like absence of protein aroma and flavour, astringency and chalkiness. Preferably the ready to mix composition comprises 45 to 55 wt. % pea and rapeseed protein.

Preferably, the present dietary fiber is a plant-based fiber. Preferably a fiber selected from the group consisting of pea fiber, fava bean fiber, lupin fiber, oil seed fiber (such as sunflower seed fiber or cotton seed fiber), fruit fiber (such as apple fiber), cereal fiber (such as oat fiber, maize fiber, rice fiber), bamboo fiber, potato fiber, inulin, and combinations thereof. Preferably the present dietary fiber is inulin derived from chicory root, or an inulin type fraction such as inulin type fructans.

Preferably, the present RTM further comprises a mineral. Preferably a mineral chosen from the group consisting of calcium phosphate, potassium phosphate, chromium chloride, copper gluconate, magnesium phosphate, manganese sulfate, potassium iodide, reduced iron, sodium molybdate, zinc sulfate, tricalcium phosphate, ferrous fumarate, magnesium oxide, potassium chloride, potassium citrate and zinc oxide.

In a preferred embodiment, the present rapeseed protein is in the form of a concentrate, or more preferably in the form of a protein isolate. A concentrate can have a protein content of 60 to 85 wt. %, a protein isolate can have a protein content of higher than 85 wt. %, such as higher than 90 wt. %.

In a preferred embodiment, said rapeseed protein is native rapeseed protein isolate comprising 40 to 65 wt. % cruciferins and 35 to 60 wt. % napins, the sum of cruciferins and napins not exceeding 100 wt. %, wherein the native rapeseed protein isolate comprises at least 5% (on dry matter) 12S rapeseed protein where the presence of 12S is verified by Blue Native PAGE.

In a preferred embodiment the present (weight) ratio of cruciferins to napins in the present protein isolate is within the range of 10:90 to 80:20 (w/w). Preferably in the range of 20:80 to 80:20 (w/w), such as 30:70 to 80:20 (w/w). In other words, the present rapeseed protein comprises an amount of napins of less than 80% of the rapeseed protein, such as less than 85%, less than 90% or even less than 95%. Puratein@HS is a rapeseed protein comprising only napins as the product is the result from the supernatant in a protein micellar mass (PMM) precipitation step as for example described in EP2323499.

Preferably, the present protein isolate does not comprise rapeseed protein having a protein profile which is:
60 to 95% (w/w) of 2S protein;
5 to 40% (w/w) of 7S protein; and
0 to 55 (w/w) of 12S protein, of the rapeseed protein, and/or having a LAB colour value of L is >75, A is-0.5 to 1.5, B is 18 to 24. Such as a LAB value of 80 (L), 0.3 (A) and 20 (B). Preferably the present protein isolate does not comprise rapeseed protein having a L value of >75, such as 80.

In a preferred embodiment the present (weight) ratio of cruciferins to napins in the rapeseed protein (isolate) is within the range of 40:60 to 60:40 (w/w) such as 45:55 to 59:41.

In another preferred embodiment, the present (weight) ratio of cruciferins to napins in the rapeseed protein (isolate) is within the range of 60:40 to 80:20 (w/w), such as 60:40 to 75:25 (w/w) or such as 65:35 to 75:25. An example of such a rapeseed protein is Puratein@ as used in the example below. Other examples are Puratein@ G, Puratein@ C.

In a preferred embodiment, the present rapeseed protein comprises 0 to 20 wt. % cruciferins and 80 to 100 wt. % napins. Preferably, the present rapeseed protein comprises 0 to 10 wt. % cruciferins and 90 to 100 wt. % napins. Preferably, the present rapeseed protein comprises 1 to 5 wt. % cruciferins and 95 to 100 wt. % napins. Preferably, the present rapeseed protein comprises around 15 wt. % cruciferins and around 85 wt. % napins. An example of such a rapeseed protein is Puratein® HS.

In a preferred embodiment, the present rapeseed protein (isolate) comprises 40 to 60 wt. % cruciferins and 40 to 60 wt. % napins. Preferably, the present rapeseed protein (isolate) comprises 45 to 55 wt. % cruciferins and 45 to 55 wt. % napins. Preferably, the present rapeseed protein (isolate) comprises around 53 wt. % cruciferins and around 47 wt. % napins. An example of such a rapeseed protein is Puratein® C.

In a preferred embodiment, the present rapeseed protein (isolate) comprises 75 to 100 wt. % cruciferins and 0 to 25 wt. % napins. Preferably, the present rapeseed protein (isolate) comprises 80 to 95 wt. % cruciferins and 5 to 20 wt. % napins. Preferably, the present rapeseed protein (isolate) comprises 85 to 95 wt. % cruciferins and 5 to 15 wt. % napins. Preferably, the present rapeseed protein (isolate) comprises around 90 wt. % cruciferins and around 10 wt. % napins. An example of such a rapeseed protein is Puratein® G.

Preferably, the amounts of cruciferins and napins are determined by size exclusion chromatography (SEC). Preferably, the amounts of cruciferins and napins are determined by size exclusion chromatography (SEC) using the following test:

samples of protein isolate, or rapeseed protein, or ready to mix composition, are dissolved in a 500 mM NaCl saline solution and analyzed by High Performance SEC using the same solution as the mobile phase, followed by detection using measuring UV absorbance at 280 nm, wherein the relative contribution of cruciferin and napin (wt. %) was calculated as the ratio of the peak area of each protein with respect to the sum of both peak areas.

Preferably the amount of cruciferins and napins is determined by Blue Native Page, HP-SEC or by sedimentation velocity (SV-AUC).

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test:

samples of protein (isolate) are dissolved in a 3.0% (or 500 mM) NaCl saline solution and amounts determined using interference optics.

In a preferred embodiment, the present rapeseed protein (isolate) comprises 0 to 20 wt. % 12S and 80 to 100 wt. % 2S. Preferably, the present rapeseed protein (isolate) comprises 0 to 10 wt. % 12S and 90 to 100 wt. % 2S. Preferably, the present rapeseed protein (isolate) comprises 1 to 5 wt. % 12S and 95 to 100 wt. % 2S. Preferably, the present rapeseed protein (isolate) comprises around 15 wt. % 12S and around 85 wt. % 2S. An example of such a rapeseed protein is Puratein® HS.

In a preferred embodiment, the present rapeseed protein (isolate) comprises 20 to 40 wt. % 12S and 50 to 80 wt. % 2S. Preferably, the present rapeseed protein (isolate) comprises 25 to 35 wt. % 12S and 55 to 70 wt. % 2S. Preferably, the present rapeseed protein (isolate) comprises 27 to 23 wt. % 12S and 56 to 65 wt. % 2S. Preferably, the present rapeseed protein (isolate) comprises around 29 wt. % 12S and around 58 wt. % 2S. An example of such a rapeseed protein is Puratein® C.

In a preferred embodiment, the present rapeseed protein (isolate) comprises 35 to 70 wt. % 12S and 15 to 40 wt. % 2S. Preferably, the present rapeseed protein (isolate) comprises 40 to 65 wt. % 12S and 20 to 35 wt. % 2S. Preferably, the present rapeseed protein (isolate) comprises 45 to 55 wt. % 12S and 25 to 35 wt. % 2S. Preferably, the present rapeseed protein (isolate) comprises around 51 wt. % 12S and around 29 wt. % 2S. An example of such a rapeseed protein is Puratein® G.

In one embodiment, the present rapeseed protein has a solubility of at least 88%, preferably at least 90%, more preferably at least 94% and most preferably at least 96% when measured over a pH range from 3 to 10 at a temperature of 23±2° C. This is also known as the soluble solids index (SSI).

Preferably the pea protein and/or rapeseed protein isolate is substantially unhydrolyzed. By substantially unhydrolyzed is meant that the protein is not deliberately hydrolyzed.

The rapeseed used to obtain the rapeseed protein isolate as applied in the instant invention is usually of the varieties Brassica napus or Brassica juncea. These varieties contain low levels of erucic acid and glucosinolates, and are the source of canola, a generic term for rapeseed oil comprising less than 2% erucic acid and less than 30 mmol/g glucosinolates. The predominant storage proteins found in rapeseed are cruciferins and napins. Cruciferins are globulins and are the major storage protein in the seed. A cruciferin is composed of 6 subunits and has a total molecular weight of approximately 300 kDa. Napins are albumins and are low molecular weight storage proteins with a molecular weight of approximately 14 kDa. Napins are more easily solubilized and are primarily proposed for use in applications where solubility is key. Rapeseed proteins can also be divided into various fractions according to the corresponding sedimentation coefficient in Svedberg units(S). This coefficient indicates the speed of sedimentation of a macromolecule in a centrifugal field. For rapeseed proteins, the main reported fractions are 12S, 7S and 2S. Napin is a 2S albumin, and cruciferin is a 12S globulin. In the context of the present invention, the rapeseed protein isolate comprises from 15 to 65% (w/w) cruciferins and from 35 to 85% (w/w) napins, the total being equal to or less than 100%. In one embodiment the rapeseed protein isolate comprises from 40 to 65% (w/w) cruciferins and from 35 to 60% (w/w) napins, the total being equal to or less than 100% (w/w).

Pea protein, obtained from yellow pea Pisum sativum, is also a mixture of various proteins (see for instance Lam et al. Food Rev. International 2018 34 (2) p126-147), consisting of globulins (70-80%) and albumins (10-20%). The globulin fraction consists of several proteins: Legumin (11S, 300-400 kDa), (7S, 150-170 kDa) and convicilin (210 kDa as trimer), the water-soluble albumin fraction consists of proteins with molecular masses up to 80 kDa comprising enzymes protease- and amylase inhibitors and lectins. Furthermore, a small fraction consists of among others prolamins and glutenins. The method of extraction highly influences the composition of the protein concentrate or isolate, as well as its physico-chemical properties and its flavour. The general process for producing a pea protein isolate is known in the art and described for instance by Frederikson et al. (J. Agric. Food Chem. 2001, 49, p1208-1212 Production Process for High-Quality Pea-Protein Isolate with Low Content of Oligosaccharides and Phytate). Several industrial methods to obtain isolates are described such as WO2020221978 (Gelling leguminous protein), US2020229462 (Pea protein composition having improved nutritional quality), EP3071045 B1 (Method for extracting pea proteins), US2020281224 (Product analogs or components of such analogs and processes for making same).

In addition to the present rapeseed protein and pea protein, the present ready to mix composition may comprise another plant-based protein, such as proteins from legumes and pulses such as, fava bean protein, chickpea protein, lupin protein, lentil protein, mung bean protein, peanut; or seed proteins such as cotton seed protein, sunflower seed protein, sesame seed protein, camelina; cereal or pseudo cereal protein, such as oat protein, rice protein, corn protein, sorghum protein, quinoa protein, buckwheat; leaf protein such as alfalfa protein, clover protein, duckweed protein, grass protein; protein from stem or root tuber protein such as potato protein, sweet potato protein, cassava protein, yam protein, taro protein; protein derived from nuts, such as almond, hazelnut, walnut, cashew; coconut protein, or proteins from algal, insect or microbial sources, or proteins produced via fermentation (i.e. precision fermentation) such as fermentative dairy milk protein or fermentative egg protein.

In another embodiment, the present ready to mix composition may comprise plant matter from legumes other than the proteins such as fibers. Preferably a plant matter from pulse. Preferably the pulse is selected from the group consisting of split peas, field peas, dry peas, lentil, chickpeas, pea bean, cow pea, roman bean, green bean, mung bean, lima bean, Madagascar bean, horse bean, pinot bean, small red bean, red Mexican bean, mottled bean, speckled sugar bean, faba bean, lima bean, garbanzo bean, kidney bean, black turtle bean, cranberry bean, green gram, green bean, black gram, urad dal, soy and/or lupin.

Preferably, the present ready to mix composition does not comprise soy protein.

Preferably the present hydrocolloid are galactomannans (guar gum, locust bean gum and tara gum), gellan (including low or high acyl gellan), xanthan, pectins, alginates, carrageenans, gum Arabic, cellulose derivatives such as carboxymethyl cellulose, hydroxypropylmethyl cellulose, methyl cellulose, native and modified starches and the like. Also, combinations of several hydrocolloids, like carboxymethyl cellulose and high acyl gellan, may be employed.

In a preferred embodiment, the present hydrocolloid is guar gum. Guar gum has shown to provide excellent ready to mix compositions that do not coat the mouth or throat.

Preferably, the present ready to mix composition comprises from 1 to 15 wt. % creaming agent, such as from 2 to 14 wt. % creaming agent, 3 to 13 wt. % creaming agent, 4 to 12 wt. % creaming agent or 5 to 10 wt. % creaming agent.

In a preferred embodiment, said creaming agent comprises maltodextrin and an oil. Preferably the creaming agent comprises medium chain triglycerides. Preferably the creaming agent comprises oil selected from the group consisting of palm, palm kernel, coconut, sunflower and rapeseed oil. Preferably the ratio of maltodextrin to oil is within the range of 40:60 to 60:40, such as 45:55 to 55:45.

In an embodiment, the ready to mix composition further comprises an emulsifier. An emulsifier promotes formation and/or stability of emulsions. Suitable emulsifiers may be the ones known to the skilled person, for example phospholipids (e.g. lecithin and the like), or calcium, magnesium, potassium, or sodium salts of fatty acids, mono- and diglycerides (MDG) and derivatives thereof such as lactic acid esters (“Lactem”) of MDG, acylated tartaric acid esters (“Datem”) of MDG, sorbitan esters of monostearate (tweens and spans). Phospholipids are natural amphiphilic molecules found in the cell and organelle membranes of animal, plant, and microbial species. These phospholipids can be isolated, purified, and utilized as surface-active ingredients in the food industry, where they are typically referred to as lecithin. The lecithin used in the food industry is usually extracted from soybeans, egg yolk, milk, sunflower kernels, or rapeseeds. Lecithin ingredients are typically mixtures of different phospholipids, with the most common being phosphatidylcholine, phosphatidylethanolamine and phosphatidylinositol. Also fractions of lecithins or modified by chemical or enzymatic treatments can be used, such as partially hydrolyzed lecithins used in oil-in-water emulsions.

In a preferred embodiment, the present ready to mix composition further comprises 1 to 5 wt. % lecithin.

Preferably, the amount of flavor is 1 to 15 wt. %, of the ready to mix composition. More preferably the amount of flavor is within the range of 2 to 14 wt. %, 3 to 12 wt. %, 4 to 10 wt. % or 3 to 9 wt. %.

In a preferred embodiment, the present flavor is vanilla and/or cacao flavor.

In a preferred embodiment, the present ready to mix composition further comprises vitamins. Preferably the vitamin is a vitamin composition comprising vitamin A, D, E, thiamin, riboflavin, niacin, pantothenic acid, pyridoxine, B12, ascorbic acid, calcium magnesium, potassium, biotin and/or folic acid. Alternatively, the vitamin is vitamin A, D, E and/or B12.

Preferably, the present ready to mix composition comprises masking agents. For example masking agents for masking protein like off flavours. Preferably, the amount of masking flavour is within 0.1 to 5 wt. % of the composition, such as from 1 to 3 wt. % of the composition.

In a preferred embodiment, the present ready to mix composition is packed in single servings, comprising 30 to 50 gram ready to mix composition.

In a preferred embodiment, the present ready to mix composition comprises less than 20 ppm gluten, less than 10 ppm gliadin and/or does not comprise soy allergens.

Further, the present invention relates to the use of the present ready to mix composition in the preparation of a food product such as a beverage, preferably having a vanilla or chocolate flavor.

The invention is further illustrated in the examples below.

### EXAMPLES

### Materials

Rapeseed protein isolate was prepared from cold-pressed rapeseed oil seed meal as described in WO 2018/007492; the protein content was 90% (w/w). The resultant rapeseed protein isolate comprised in the range of from 40 to 65% (w/w) cruciferins and 35 to 60% (w/w) napins, contained less than 0.26% (w/w) phytate and had a solubility of at least 88% when measured over a pH range from 3 to 10 at a temperature of 232° C. The other used materials are indicated in the examples below.

### Example 1

### Preparation of a Weight Management Ready to Mix Having Chocolate Flavor

RTM's were prepared by dry blending the ingredients as shown in table 1.

Subsequently, drinks were made by blending 35 gram of the RTM in 240 ml of water followed by hand shaking for 10 seconds.

TABLE 1

| | Percentage of |
|---|---|
| Ingredients chocolate flavor RTM | Total Formula |
| Rapeseed protein isolate | 25.64% |
| Vegotein-N, Pea Protein (Axiom) | 25.64% |
| Orafti P95 - Inulin (dietary fiber) | 13.18% |
| Jerzee CWS-80BXS - 175620 - 49% Sunflower | 11.89% |
| Cocoa Powder Montgomery 10/12 Alkalized Cocoa | 7.53% |
| Natural Vanilla Type Flavor US1025P | 3.77% |
| Natural Cocoa Flavor WONF P4321P | 2.82% |
| Vit/Min Premix CanolaPRO ® Demo - XR72937000 | 2.58% |
| De-Oiled Sunflower Lecithin Powder | 2.12% |
| Guar NT USA Flavor Free 5000 | 2.00% |
| Magnifique Green Away Powder | 1.88% |
| Salt | 0.47% |
| Magnifique ProNo Powder | 0.24% |
| EverSweet 02 Stevia | 0.23% |

The RTM was tested in a quantitative descriptive assessment (QDA) with n=10 in comparison with a benchmark product Orgain Creamy Chocolate Fudge comprising pea, brown rice and chia protein). The results are shown in table 2 below.

TABLE 2

| | | Chocolate | |
|---|---|---|---|
| | | Orgain | |
| | RTM | Organic | |
| | example 1 | Protein | P-Value |
| APPEARANCE: | | | |
| Brown Color | 9.0 | 8.6 | 0.4742 |
| AROMA: | | | |
| Total Aroma | 4.2 A | 3.8 B | 0.0383 |
| Cocoa | 3.2 A | 1.7 B | 0.0003 |
| Protein | 1.7 | 1.9 | 0.2644 |
| Cherry | 0.0 a | 0.0 b | 0.0946 |
| Total Off | 0.4 B | 1.2 A | 0.0220 |
| FLAVOR: | | | |
| Total Flavor | 4.3 | 3.9 | 0.1790 |
| Cocoa | 3.2 A | 1.9 B | <.0001 |
| Protein | 1.5 B | 2.1 A | 0.0082 |
| Cherry | 0.0 | 0.1 | 0.2041 |
| Total Off | 0.5 B | 1.0 A | 0.0128 |
| Sweet | 2.7 A | 2.0 B | 0.0263 |
| Bitter | 1.1 | 1.2 | 0.4593 |
| Salty | 0.9 A | 0.7 B | 0.0263 |
| TEXTURE/FEELING FACTORS: | | | |
| Astringency | 1.7 | 2.0 | 0.3079 |
| Viscosity | 2.3 | 2.4 | 0.6719 |
| Chalky | 2.5 B | 3.3 A | <.0001 |
| AFTERTASTE: | | | |
| Total Aftertaste | 3.3 A | 2.4 B | 0.0047 |

The above shows that the RTM of the invention scores similar in many attributes as the benchmark. Specifically, the RTM of the invention provided less total off aroma and total off flavor, less protein flavor and less chalkiness. Further, the RTM of the invention provided significantly more cocoa aroma and cocoa flavor and was sweeter.

### Example 2

### Preparation of a Weight Management Ready to Mix Having Vanilla Flavor

RTM's were prepared by dry blending the ingredients as shown in table 3. Subsequently, drinks were made by blending 35 gram of the RTM in 240 ml of water followed by hand shaking for 10 seconds.

TABLE 3

| | Percentage of |
|---|---|
| Ingredients vanilla flavor RTM | Total Formula |
| Rapeseed protein isolate | 24.97% |
| Vegotein-N, Pea Protein (Axiom) | 24.97% |
| Orafti P95 - Inulin (dietary fiber) | 16.16% |
| Jerzee CWS-80BXS - 175620 - 49% Sunflower | 14.53% |
| Natural French Vanilla Type Flavor W10050 | 4.05% |
| Natural Vanilla Type Flavor US1025P | 4.05% |
| Vit/Min Premix CanolaPRO ® Demo - XR72937000 | 2.56% |
| De-Oiled Sunflower Lecithin Powder | 2.06% |
| Guar NT USA Flavor Free 5000 | 1.98% |
| Magnifique Astringency Away Powder | 1.83% |
| Magnifique Green Away Powder | 1.83% |
| Salt | 0.46% |
| Magnifique ProNo Powder | 0.43% |
| EverSweet 02 Stevia | 0.12% |

The RTM was tested in a quantitative descriptive assessment (QDA) with n=10 in comparison with a benchmark product Garden of Life vanilla comprising pea and brown rice protein). The results are shown in table 4 below.

TABLE 4

| | | Vanilla | |
|---|---|---|---|
| | RTM | Garden | |
| | example 2 | of Life | P-Value |
| APPEARANCE: | | | |
| Brown Color | 3.9 | 4.2 | 0.3587 |
| AROMA: | | | |
| Total Aroma | 3.3 | 3.4 | 0.6279 |
| Cinnamon | 0.7 b | 1.2 a | 0.0521 |
| Vanilla | 2.3 A | 1.2 B | 0.0002 |
| Protein | 1.5 | 1.9 | 0.1112 |
| Total Off | 0.5 B | 1.1 A | 0.0164 |
| FLAVOR: | | | |
| Total Flavor | 3.6 | 3.8 | 0.3554 |
| Cinnamon | 0.9 | 0.9 | 0.9127 |
| Vanilla | 2.3 A | 1.0 B | 0.0004 |
| Protein | 1.6 B | 2.4 A | 0.0013 |
| Total Off | 0.5 B | 1.5 A | 0.0008 |
| Sweet | 2.6 | 2.3 | 0.3225 |
| Bitter | 0.8 | 0.9 | 0.6701 |
| Salty | 0.8 | 1.0 | 0.5925 |
| TEXTURE/FEELING FACTORS: | | | |
| Astringency | 1.5 | 1.7 | 0.4931 |
| Viscosity | 2.8 | 3.1 | 0.3148 |
| Chalky | 2.3 B | 4.4 A | <.0001 |
| AFTERTASTE: | | | |
| Total Aftertaste | 3.6 a | 2.7 b | 0.0564 |

The RTM of the invention provided significantly less total off aroma and total off flavor, less protein flavor and less chalkiness. The RTM of the invention provided significantly more vanilla aroma and flavor than the benchmark, with no significant difference in sweetness.

### Example 3

### Preparation of a Sport Ready to Mix Having Chocolate Flavor

RTM's were prepared by dry blending the ingredients as shown in table 5. Subsequently, drinks were made by blending 40 gram of the RTM in 240 ml of water followed by hand shaking for 10 seconds.

TABLE 5

| | Percentage of |
|---|---|
| Ingredients chocolate flavor RTM | Total Formula |
| Rapeseed protein isolate | 31.13% |
| Vegotein-N, Pea Protein (Axiom) | 31.13% |
| Richmix 5024 IP - 175755 - 52% MCT | 8.24% |
| Cocoa Powder Montgomery 10/12 Alkalized Cocoa | 6.10% |
| Orafti P95 - Inulin | 4.85% |
| Natural Vanilla Type Flavor US1025P | 3.68% |
| Natural Cocoa Flavor WONF P4321P | 2.76% |
| Vit/Min Premix CanolaPRO ® Demo - XR72937000 | 2.57% |
| De-Oiled Sunflower Lecithin Powder | 2.07% |
| Granulated White Sugar | 1.87% |
| Magnifique Astringency Away Powder | 1.84% |
| Magnifique Green Away Powder | 1.84% |
| Guar Gum | 1.01% |
| Magnifique ProNo Powder | 0.48% |
| Salt | 0.30% |
| EverSweet 02 Stevia | 0.11% |

The RTM was tested in a quantitative descriptive assessment (QDA) with n=10 in comparison with a benchmark product VegaSport Chocolate comprising pea, pumpkin seed, sunflower seed and alfalfa protein). The results are shown in table 6 below.

TABLE 6

| | RTM | Chocolate | |
|---|---|---|---|
| | example 3 | Vega Sport | P-Value |
| APPEARANCE: | | | |
| Brown Color | 9.7 A | 7.7 B | <.0001 |
| AROMA: | | | |
| Total Aroma | 4.5 A | 3.9 B | 0.0166 |
| Cocoa | 3.4 A | 2.0 B | <.0001 |
| Protein | 1.6 | 1.4 | 0.2468 |
| Cherry | 0.0 B | 1.7 A | 0.0001 |
| Total Off | 0.4 | 0.7 | 0.1170 |
| FLAVOR: | | | |
| Total Flavor | 4.1 | 4.3 | 0.4589 |
| Cocoa | 3.2 A | 2.0 B | <.0001 |
| Protein | 1.5 | 1.7 | 0.2424 |
| Cherry | 0.0 B | 1.7 A | <.0001 |
| Total Off | 0.7 | 1.0 | 0.1621 |
| Sweet | 1.9 | 2.0 | 0.6447 |
| Bitter | 1.3 A | 0.8 B | 0.0043 |
| Salty | 0.9 | 0.7 | 0.1057 |
| TEXTURE/FEELING FACTORS: | | | |
| Astringency | 1.9 a | 1.6 b | 0.0822 |
| Viscosity | 2.3 B | 4.1 A | <.0001 |
| Chalky | 3.3 | 3.3 | 0.8212 |
| AFTERTASTE: | | | |
| Total Aftertaste | 3.1 A | 2.4 B | 0.0136 |

The RTM of the invention provided significantly less viscosity and provided significantly more cocoa aroma and cocoa flavor than the benchmark. The lower viscosity indicates that the amount of protein can be further increased while providing a sport drink.

### Example 4

### Preparation of a Sport Ready to Mix Having Vanilla Flavor

RTM's were prepared by dry blending the ingredients as shown in table 7. Subsequently, drinks were made by blending 40 gram of the RTM in 240 ml of water followed by hand shaking for 10 seconds.

TABLE 7

| | Percentage of |
|---|---|
| Ingredients vanilla flavor RTM | Total Formula |
| Rapeseed protein isolate | 31.18% |
| Vegotein-N, Pea Protein (Axiom) | 31.18% |
| Richmix 5024 IP - 175755 - 52% MCT | 9.66% |
| Orafti P95 - Inulin | 7.86% |
| Natural Vanilla Type Flavor US1025P | 4.03% |
| Natural French Vanilla Type Flavor W10050 | 4.03% |
| Vit/Min Premix CanolaPRO ® Demo - | 2.54% |
| XR72937000 | |
| De-Oiled Sunflower Lecithin Powder | 2.05% |
| Granulated White Sugar | 1.85% |
| Magnifique Astringency Away Powder | 1.82% |
| Magnifique Green Away Powder | 1.82% |
| Guar Gum | 1.00% |
| Salt | 0.46% |
| Magnifique ProNo Powder | 0.43% |
| EverSweet 02 Stevia | 0.09% |

The RTM was tested in a quantitative descriptive assessment (QDA) with n=10 in comparison with a benchmark product Vanilla ON Gold comprising whey protein). The results are shown in table 8 below.

TABLE 8

| | RTM | Vanilla ON | |
|---|---|---|---|
| | example 4 | Gold Standard | P-Value |
| APPEARANCE: | | | |
| Brown Color | 4.9 A | 3.6 B | <.0001 |
| AROMA: | | | |
| Total Aroma | 3.9 | 4.0 | 0.5778 |
| Cinnamon | 0.8 B | 2.2 A | 0.0009 |
| Vanilla | 2.4 A | 0.8 B | <.0001 |
| Protein | 1.7 | 1.7 | 0.8130 |
| Total Off | 0.6 | 0.8 | 0.4097 |
| FLAVOR: | | | |
| Total Flavor | 3.8 | 3.8 | 0.8106 |
| Cinnamon | 0.9 B | 2.4 A | 0.0014 |
| Vanilla | 2.4 A | 0.8 B | <.0001 |
| Protein | 1.9 | 1.7 | 0.1226 |
| Total Off | 0.6 B | 1.1 A | 0.0052 |
| Sweet | 2.7 A | 2.1 B | 0.0196 |
| Bitter | 0.7 | 0.9 | 0.2873 |
| Salty | 1.2 A | 0.8 B | 0.0325 |
| TEXTURE/FEELING FACTORS: | | | |
| Astringency | 1.5 | 2.0 | 0.1303 |
| Viscosity | 2.4 B | 4.0 A | <.0001 |
| Chalky | 2.4 B | 4.1 A | 0.0021 |
| AFTERTASTE: | | | |
| Total Aftertaste | 3.9 A | 2.5 B | 0.0001 |

The RTM of the invention provided significantly less total off flavor and total off aroma and less chalkiness. Further, the RTM of the invention provided significantly more vanilla aroma and flavor than the benchmark. The RTM of the invention provided significantly less viscosity. The lower viscosity indicates that the amount of protein can be further increased while providing a sport drink.

### Example 5

RTMs with Different Ratios of Pea and Rapeseed Protein

RTM's were prepared by dry blending the ingredients as shown in table 8. This recipe is similar to the RTM recipe in example 4, except that the three Magnifique masking agents were replaced by equal amounts of water. Variations are made in the ratio of pea and rapeseed protein (see table 9), and subsequently to the source of the rapeseed protein (see table 10). Drinks were made by blending 40 gram of the RTM in 240 ml of water followed by hand shaking for 10 seconds.

TABLE 8

| | Percentage of |
|---|---|
| Ingredients | Total Formula |
| Total protein isolate (rapeseed + pea | 62.36% |
| protein) | |
| Richmix 5024 IP - 175755 - 52% MCT | 9.66% |
| Orafti P95 - Inulin | 7.86% |
| Natural Vanilla Type Flavor US1025P | 4.03% |
| Natural French Vanilla Type Flavor W10050 | 4.03% |
| Vit/Min Premix CanolaPRO ® Demo - | 2.54% |
| XR72937000 | |
| De-Oiled Sunflower Lecithin Powder | 2.05% |
| Granulated White Sugar | 1.85% |
| Guar Gum | 1.00% |
| Salt | 0.46% |
| EverSweet 02 Stevia | 0.09% |
| Water to compensate for masking agent | 4.07% |
| removal | |

The RTMs with different ratios of pea and rapeseed protein were tested in a quantitative descriptive assessment (QDA) with n=5, assessing the attributes astringency, chalkiness and off flavour. The results are shown in table 9 below.

TABLE 9

| | Ratio pea:rapeseed protein | | | | |
|---|---|---|---|---|---|
| | 100:0 | 75:25 | 50:50 | 25:75 | 0:100 |
| Astringency | 2.4 | 1.6 | 2.0 | 2.0 | 3.9 |
| Chalkiness | 4.6 | 3.1 | 2.5 | 1.5 | 1.4 |
| Off flavour | 4.6 | 2.0 | 2.6 | 3.2 | 3.7 |

The results show that the blends of pea and rapeseed protein reduce the astringency and off flavour (compared to pea or rapeseed protein only) and reduce the chalkiness of pea protein.

Further, RTMs with different rapeseed protein isolate (in a 50:50 ratio pea: rapeseed protein) were tested in a quantitative descriptive assessment (QDA) with n=5, using the attributes astringency, chalkiness and off flavour. The results are shown in table 10 below.

TABLE 10

| | Rapeseed protein isolate | | | |
|---|---|---|---|---|
| | | Puratein ®HS | Puratein ®G | Puratein ®C |
| | CanolaPro ® | from Merit | from Merit | from Merit |
| | from DSM | Foods | Foods | Foods |
| Astringency | 2.0 | 2.4 | 1.8 | 2.0 |
| Chalkiness | 2.5 | 4.0 | 3.1 | 2.4 |
| Off flavour | 2.6 | 3.2 | 2.6 | 2.7 |

The results show that, compared to pea only (from table 9) all four rapeseed protein isolates improve the chalkiness and reduce the off flavour. The astringency is reduced too.

1. A ready to mix composition comprising 30 to 60 wt. % pea and rapeseed protein, 5 to 25 wt. % dietary fiber, 0 to 15 wt. % creaming agent, 1 to 15 wt. % flavor and 0.1 to 5 wt. % hydrocolloid, wherein the ratio of pea and rapeseed protein is within the range of 80:20 to 20:80.

2. The ready to mix composition of claim 1, wherein the composition further comprises 0.01 to 5 wt. % of a sweetener.

3. The ready to mix composition of claim 1, wherein the ratio of pea and rapeseed protein is within the range of 60:40 to 40:60.

4. The ready to mix composition of claim 1, wherein the composition comprises 35 to 45 wt. % pea and rapeseed protein, 10 to 25 wt. % dietary fiber, 10 to 15 wt. % creaming agent, 1 to 15 wt. % flavor and 1 to 4 wt. % hydrocolloid.

5. The ready to mix composition of claim 1, wherein the composition comprises 45 to 55 wt. % pea and rapeseed protein, 1 to 10 wt. % dietary fiber, 5 to 15 wt. % creaming agent, 1 to 15 wt. % flavor and 0.1 to 3 wt. % hydrocolloid.

6. The ready to mix composition of claim 1, wherein said rapeseed protein comprises cruciferins and napins, preferably wherein the ratio of cruciferins to napins in the protein isolate is within the range of 10:90 to 80:20, preferably 40:60 to 65:35, preferably, 50:50 to 80:20.

7. The ready to mix composition of claim 1, wherein said hydrocolloid is guar gom.

8. The ready to mix composition of claim 1, wherein said creaming agent comprises maltodextrin and an oil.

9. The ready to mix composition of claim 1, further comprising 1 to 5 wt. % lecithin.

10. The ready to mix composition of claim 1, wherein said flavor is vanilla and/or cacao flavor.

11. The ready to mix composition of claim 1, wherein the composition further comprises vitamins.

12. The ready to mix composition of claim 1, wherein the composition is packed in single servings, comprising 30 to 50 gram ready to mix composition.

13. The ready to mix composition of claim 1, wherein the composition comprises less than 20 ppm gluten, less than 10 ppm gliadin and/or does not comprise soy allergens.

14. A method for the preparation of a food product comprising mixing the ready to mix composition of claim 1 and water.

15. The method of claim 14, wherein the beverage is a chocolate or vanilla flavored beverage.

16. The method of claim 14, wherein the food product is a beverage.
